(19) United States
(12) Patent Application Publication
(10) Pub. No.: US 2004/0199721 A1
(43) Pub. Date: Oct. 7, 2004

(54) Multi-transmission interface memory card

(75) Inventor: Chien-Yuan Chen, Banchiau City (TW)

Correspondence Address: TROXELL LAW OFFICE PLLC, 5205 LEESBURG PIKE, SUITE 1404, FALLS CHURCH, VA, 22041, US

(73) Assignee: Power Data Communication Co., Ltd.

(21) Appl. No.: 10/385,735

(22) Filed: Mar. 12, 2003

(51) Int. Cl. G06F 12/00

(52) U.S. Cl. 711/115; 710/305

(57) ABSTRACT

The multi-transmission interface memory card is characterized by the dual interface capacity of its memory control chip. The multi-transmission interface memory card is simultaneously compatible to two modes of data interfacing, it enables the easy interfacing between the computers with a number of electronic (terminal) devices or the easy interfacing between the two of many these electronics devices.

### BACKGROUND OF THE INVENTION

1) Field of the Invention

The invention relates to a multi-transmission interface memory card, particularly to a memory card control chip having dual interface capacity. It is therefore capable of fast data transmission and also physically compact and more user friendly.

2) Description of the Prior Art

The memory cards used in digital cameras, MP3, mobile phones and PDAs (Personal Digital Assistant) enjoy great popularity due to their advantages in large memory capacity, compact physical size, ease to carry and etc. The major memory card products in the industry, such as smart digital, memory stick, compact flash, smart media, multi media card, MD (Mini Disk), come in various shapes and sizes. In order to access the memory from computer systems, it is necessary to use a (memory) card reading device. Due to the variety of card products, it is uneconomical for computer users to have a number of different card reading devices to access different types of data. As computers are getting more and more compact, it is also unrealistic for user to carry a number of different card reading devices. In addition, as card memory capacity enjoys fast growth with new technical breakthrough, the reading speed on USB (Universal Serial Bus) or other connection interface becomes the bottle neck in the process. Even though a PCMCIA (Personal Computer Memory Card Interface Association) presently helps to eliminate the problem of the slow reading speed on serial port interfaces, it is still restricted by the reading speed limit on flash memory. The PCMCIA is basically for notebook computers while different notebooks come with different sockets. The PCMCIA therefore does not offer a general solution to the “slow reading speed” problem.

One example of the existing patent is the Flash EEPROM System, (U.S. Pat. No. 5,602,987). Referring to FIG. 1, the invention provides a memory card connecting to a computer system, wherein the flash EEPROM array (33) is connected to a controller (31) to constitute a non-volatile memory (29) as shown in the drawing. The non-volatile memory (29) leads to at least one set of input-output device, I/O Device (27). The I/O Device is connected to the micro processor (21) and the R.A.M. (25) via a system bus (23). This design maintains high accuracy in the large capacity cyclic access operations, yet it can not meet the high transmission speed and high compatibility requirements.

Another example of the conventional patent, Architecture for a USB-Based PC Flash Disk (U.S. Pat. No. 6,148,354), is shown in FIG. 2; this device consists mainly of a connecting interface (64) between a flash components (58) and a USB connector (52). The connecting interface (64) has a USB logical/physical interface (66) and a USB function interface (68). The USB function interface (68) sends signals through the sequence of an application packet extractor (70), an application command interpreter (72), an address resolver (74), a data and status handler. (76) and a memory technical driver (MTD 78) for processing, then transmitting them to flash components (58). This architecture constitutes a flash memory module that users can access or delete data from a computer. This conventional patent is flawed due to the fact that the flash memory unit can only be accessed from a computer, but not be used in the terminal device to terminal device, peer to peer network structure situation for resources (data) sharing.

A third example in this area is Dual Interface Memory Card with Conversion Module (Taiwan Utility Patent Publication No. 481314), refer to FIG. 3. This invention provides a memory section (20) and a micro control module (10). The micro control unit (10) has a USB interface and a host interface. The USB interface is used to link to a computer to enable it to read/write data on the memory section. The host interface is for linkage to other devices with memory card installations in order to access data. This invention uses a conversion module in conjunction with a computer in order to access data directly, thus enhancing the accessing efficiency. Nevertheless, this very architecture is still that of a traditional card reading device. The conversion module is selective with regard to the types of memory card in use. Different memory cards have to be paired with the right conversion modules to link to the computer.

### SUMMARY OF THE INVENTION

Thus, the main objective of the present invention is to provide a memory card with multiple transmission interfaces, characterized by a memory control chip that has dual-interfacing capability. The memory card can interface in two modes, thereby achieving a more convenient, versatile compatibility with computers and a large number of terminal devices. It is also capable of transmitting (accessing) data at much better speed while operating in a reduced physical size and at a lower cost.

### BRIEF DESCRIPTION OF THE DRAWINGS

FIG. 1 is a block diagram of a conventional flash EEROM system device.

FIG. 2 is a block diagram of a conventional Architecture for a USB-Based PC Flash Disk device.

FIG. 3 is a block diagram for a conventional dual interface memory card with a conversion module.

FIGS. 4A and 4B are pictorial and schematic drawings showing a preferred embodiment on both sides according to the present invention.

FIG. 5 is a block diagram showing the preferred embodiment according to the present invention.

FIG. 6 is a block diagram showing the preferred embodiment according to the present invention.

FIG. 7 is a circuit diagram illustrating the relationship of the circuit according to the present invention.

FIGS. 8A and 8B are perspective drawings showing another preferred embodiment on both sides according to the present invention.

FIGS. 9A and 9B are exploded and schematic drawings showing further preferred embodiment of the present invention.

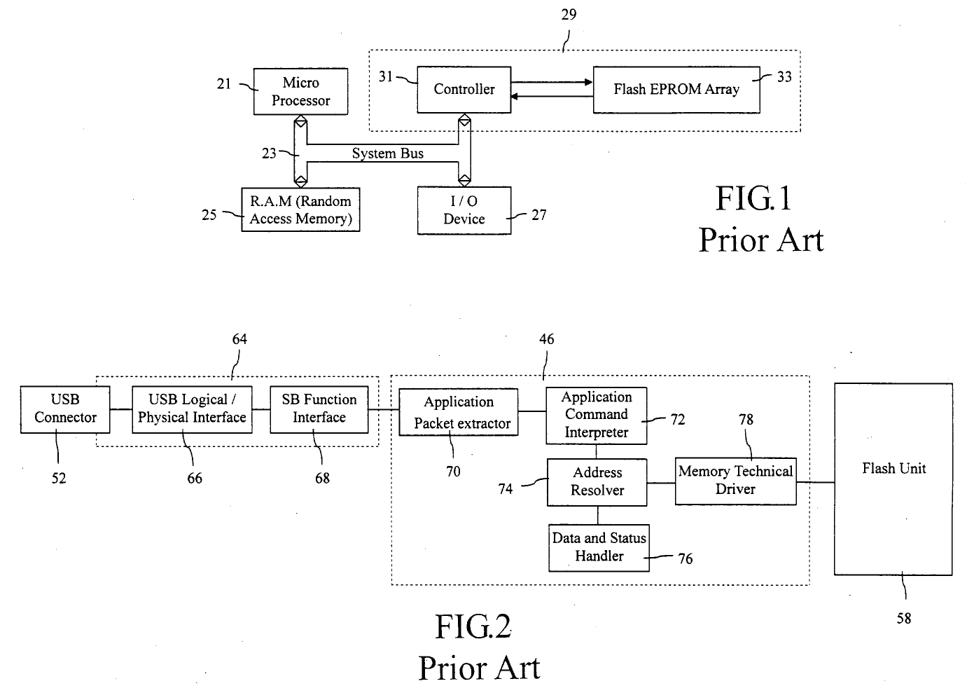

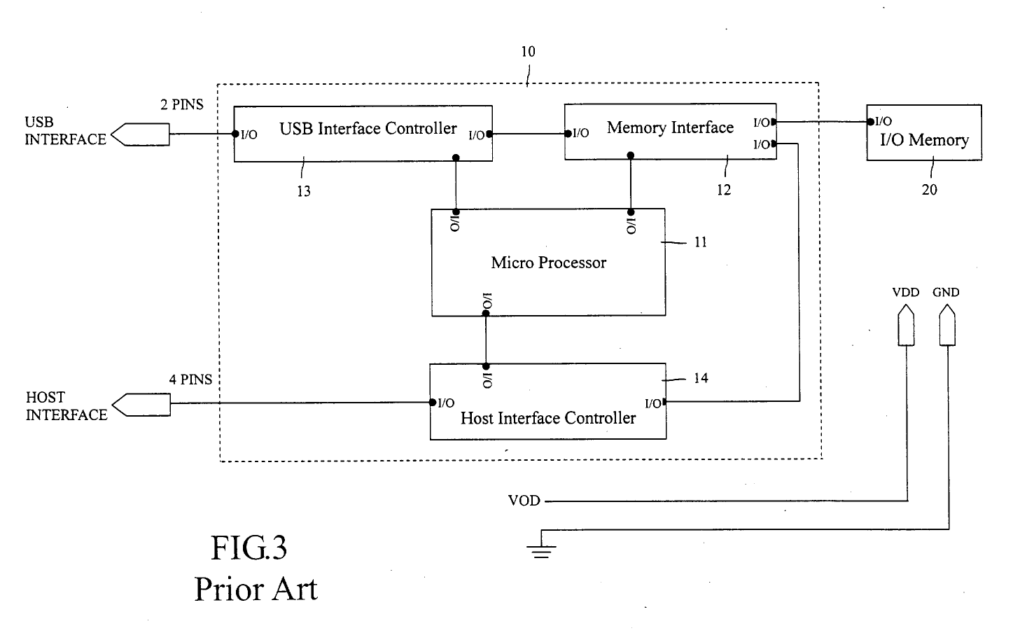

### DETAILED DESCRIPTION OF THE PREFERRED EMBODIMENT

To enable a further understanding of the said objectives and the technological methods of the invention herein, the brief description of the drawings below is followed by the detailed description of the preferred embodiments.

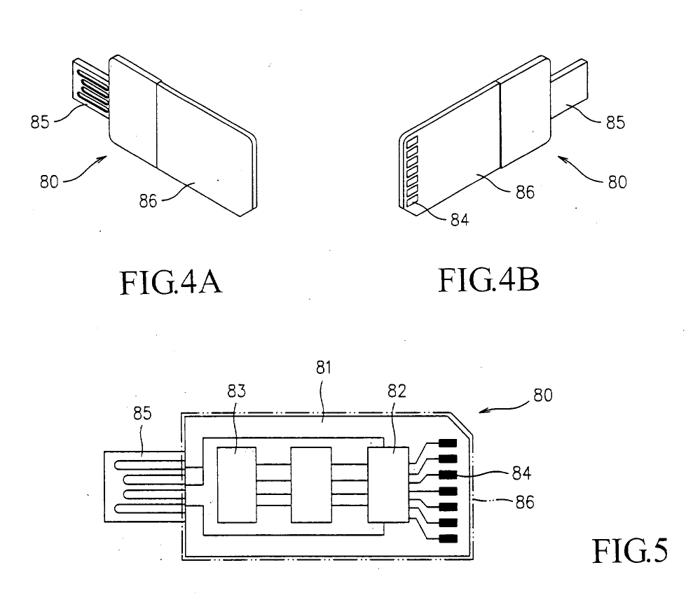

Referring to FIGS. 4A and 4B, a preferred embodiment from different viewing angles for a multi-transmission interface memory card (80), consists of a main memory section (86). The main memory section (86) in turn, includes two separate parts: a memory interface (84) and a connection interface (85). The memory interface (84) could be any of the following components: smart digital memory, memory stick, compact flash, smart media, multi media card, IBM micro drive, and etcetera. The connection interface can either be a USB or IEEE 1394 connector.

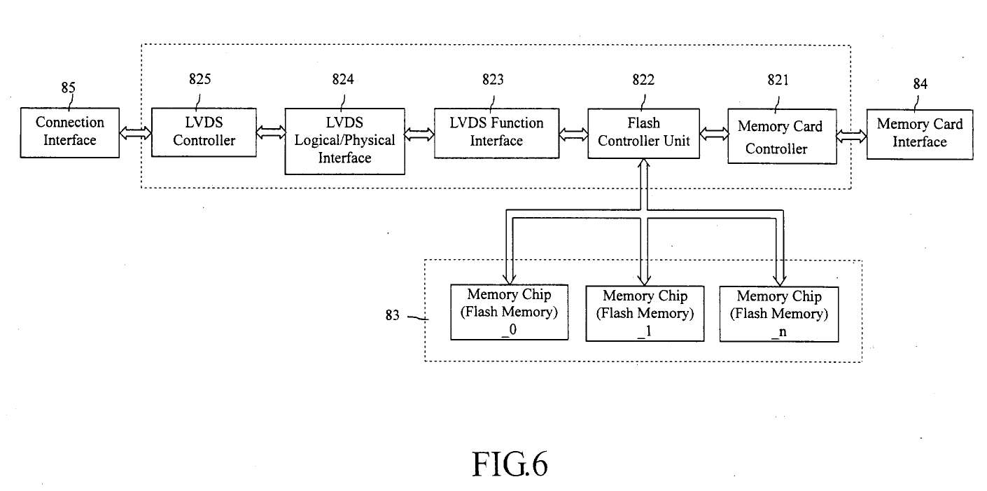

Referring to FIGS. 5 to 7, the main memory section (86) has a circuit board (81) therein, and said memory interface (84) and connection interface (85) are both connected to the circuit board (81). There is a control chip (82) on the circuit board (81) connected to the memory interface (84); and at least one memory chip (83) and one control chip (82) connected to the connection interface (85) (See FIG. 5). This control chip (82) includes a memory controller (821), a flash controller unit (822), a LVDS function interface (823), a LVDS logical/physical interface (824), and a LVDS controller (825) (See FIG. 6).

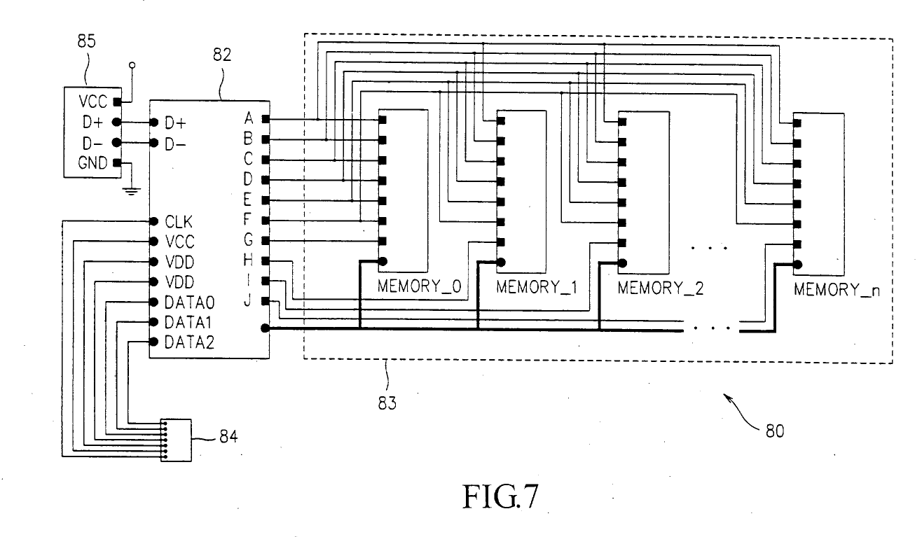

The multi-transmission interface memory card (80) is connected to a computer system via connection interface (85), so that data can be 2( ) exchanged between a computer system and the card (80) with the control chip (82) in charge of the data conversion (See FIG. 7). In other word, the control chip (82) has a dual-interface design, on one side there is the memory interface (84), on the other side there is the USB or IEEE 1394 interface.

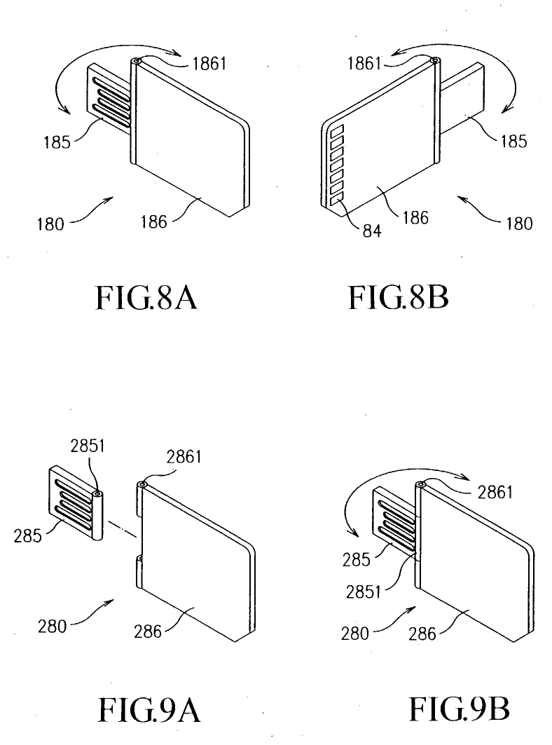

Referring to FIGS. 8A and 8B, the main memory section (186) and connection interface (185) of the memory card (180) were linked by an axial element (1861). The memory interface (184) and connection interface (185) are electrically connected, whereas the connection interface (185) can rotate around axial element (1861). When connection interface (185) is inserted in a computer, the memory card (180) may be disposed at any possible angle to the computer and is therefore highly flexible to use.

Lastly, referring to FIGS. 9A and 9B, the connection interface (285) and main memory section (286) of the memory card (280) are linked by axial elements (2851) and (2861), respectively with (285) and (286). Axial elements (2851) and (2861) are electrically connected (not shown in the drawing). Similar to the preferred embodiment as shown in FIGS. 8A and 8B, the connection interface (285) can also rotate around axial elements 2851 and 2862, allowing the memory card (280) to be disposed at any angle thereby achieving a greater flexibility while in use.

The main feature of the present invention is that multi-transmission interface memory card (80) includes the controller chip (82) that has dual-interface capacity, through the memory interface (84) and the connection interface (85). It offers the following advantages:

1) It makes possible the more versatile compatibility among a number of electronic (terminal) devices. It achieves the terminal to computer, terminal to terminal data accessing capability

2) The USB or IEEE1394 standard series connection interface (85) has transmitting efficiency far exceeds the transmitting speed of the traditional memory card.

3) It eliminates the need for data reading devices, therefore offers better economy for the computer users.

4) The convenience of not having to use any data reading devices.

It is to be understood that the embodiment described herein is merely illustrative of the principles of the invention and that a wide variety of modifications thereto may be effected by persons skilled in the art without departing from the spirit and scope of the invention as set forth in the following claims.

1. A multi-transmission interface memory card comprising:
a main memory card section;
a control chip;
a memory chip;
a memory interface, connecting to the control chip;
a connection interface, connecting to the memory chip;
the main memory card section, control chip, memory chip, memory interfaces and connection interfaces are all electrically connected to enable the memory card the dual interfacing capacity.

2 The multi-transmission interface card of claim 1, wherein the control chip comprising: a memory controller, a flash controller unit, a LVDS function interface, a LVDS logical/physical interface, and a LVDS controller.

3 The multi-transmission interface card of claim 1, wherein the memory chip comprising a plurality of flash memory.

4 The multi-transmission interface card of claim 1, wherein the memory chip comprising a plurality of read only memory.

5 The multi-transmission interface card of claim 1, wherein the connection interface is an USB connector interface or an IEEE 1394 standard serial connector interface.

6 The multi-transmission interface card of claim 1, wherein the main memory card section is linked with the connector interface by axial elements, enabling the connector interface to rotate around the linkage axis.
